(19) United States
(12) Patent Application Publication
(10) Pub. No.: US 2009/0053587 A1
(43) Pub. Date: Feb. 26, 2009

(54) Abnormality detecting device for a fuel cell powered industrial vehicle

(76) Inventor: Hideyuki Tanaka, Aichi-ken (JP)

Correspondence Address: MORGAN & FINNEGAN, L.L.P., 3 WORLD FINANCIAL CENTER, NEW YORK, NY, 10281-2101, US

(21) Appl. No.: 12/221,500

(22) Filed: Aug. 4, 2008

(30) Foreign Application Priority Data
Aug. 6, 2007 (JP) 2007-204053

(51) Int. Cl. H01M 10/48; H01M 8/02

(52) U.S. Cl. 429/90

(57) ABSTRACT

An abnormality detecting device for a fuel cell powered industrial vehicle confirms whether a radiator fan is at rest or not (S1), and when the fan is at rest, a first setting concentration N1 is selected and set as an abnormality detection threshold value TH (S2). Conversely, when the fan is driven, a second setting concentration N2 for detecting a lower concentration is selected and set as the abnormality detection threshold value TH (S3). A hydrogen concentration Nm detected by a hydrogen concentration sensor is input (S4), and the input hydrogen concentration Nm is compared with the abnormality detection threshold value TH (S5). If the detected hydrogen concentration Nm is lower than or equal to the abnormality detection threshold value TH, it is determined as normal (S6), and if the detected hydrogen concentration Nm exceeds the abnormality detection threshold value TH, it is determined as abnormal (S7).

### BACKGROUND OF THE INVENTION

1. Field of the Invention

The present invention relates to an abnormality detecting device for a fuel cell powered industrial vehicle, and more particularly, to a device for detecting an abnormality on the basis of hydrogen concentration in a fuel cell unit.

2. Description of the Related Art

In recent years, industrial vehicles such as fuel cell powered forklifts have been developed on which a fuel cell is mounted as a driving source. In the fuel cell, it is known that a slight amount of hydrogen, a reactive gas, is emitted due to permeance or leakage of hydrogen from respective parts. In cases where the amount of emission of hydrogen increases more than the normal amount due to some failure of the fuel cell and so on, it is necessary to rapidly detect such abnormalities.

In a fuel cell powered automobile disclosed in, for example, JP 2004-40950 A, in order to prevent hydrogen from remaining in the space where the fuel cell is installed, the hydrogen concentration in the space is detected, and a ventilation fan or a radiator fan for cooling the fuel cell is operationally controlled according to the detected hydrogen concentration, thereby promoting ventilation of the installation space.

If the hydrogen concentration in the space where the fuel cell is installed is detected, it will be possible to detect the abnormality, as in the fuel cell powered automobile disclosed in JP 2004-40950 A. However, in the case where the fan of the radiator starts when the fuel cell is overheated, the surrounding atmosphere of the fuel cell is agitated, resulting in a risk that the hydrogen concentration in the installation space cannot be detected with precision.

### SUMMARY OF THE INVENTION

The present invention has been made to solve the problems described above, and it is therefore an object of the present invention to provide an abnormality detecting device for a fuel cell powered industrial vehicle, which can detect abnormalities with precision regardless of the driving or stopping of a radiator fan for cooling the fuel cell.

The abnormality detecting device for a fuel cell powered industrial vehicle relating to the present invention is for a vehicle that includes a fuel cell unit having a fuel cell and which starts a radiator fan to cool the fuel cell when the fuel cell is overheated, the abnormality detecting device comprising:
a hydrogen concentration detecting device arranged in the fuel cell unit; and

a control device in which a first setting concentration set as an abnormality detecting threshold value when the fan is at rest and a second setting concentration set as an abnormality detecting threshold value that is lower than the first setting concentration when the fan is driven,

wherein the control device determines there is an abnormality when the hydrogen concentration that is detected by the hydrogen concentration detecting device exceeds the abnormality detection threshold value.

### BRIEF DESCRIPTION OF THE DRAWINGS

FIG. 1 is a diagram showing a configuration of a fuel cell powered forklift including an abnormality detecting device according to a first embodiment of the present invention;

FIG. 2 is a block diagram showing a configuration of the abnormality detecting device according to the first embodiment;

FIG. 3 is a flowchart showing an operation of the abnormality detecting device according to the first embodiment;

FIG. 4 is a block diagram showing a configuration of an abnormality detecting device according to a second embodiment of the present invention;

FIG. 5 is a diagram showing a configuration of a fuel cell powered forklift including an abnormality detecting device according to a third embodiment of the present invention;

FIG. 6 is a block diagram showing a configuration of the abnormality detecting device according to the third embodiment;

FIG. 7 is a flowchart showing an operation of the abnormality detecting device according to the third embodiment;

FIG. 8 is a block diagram showing a configuration of an abnormality detecting device according to a fourth embodiment of the present invention;

FIG. 9 is a block diagram showing a configuration of an abnormality detecting device according to a fifth embodiment of the present invention; and

FIG. 10 is a flowchart showing an operation of the abnormality detecting device according to the fifth embodiment.

### DETAILED DESCRIPTION OF THE PREFERRED EMBODIMENTS

Hereinafter, a description will explain preferred embodiments of the present invention with reference to the accompanying drawings.

### First Embodiment

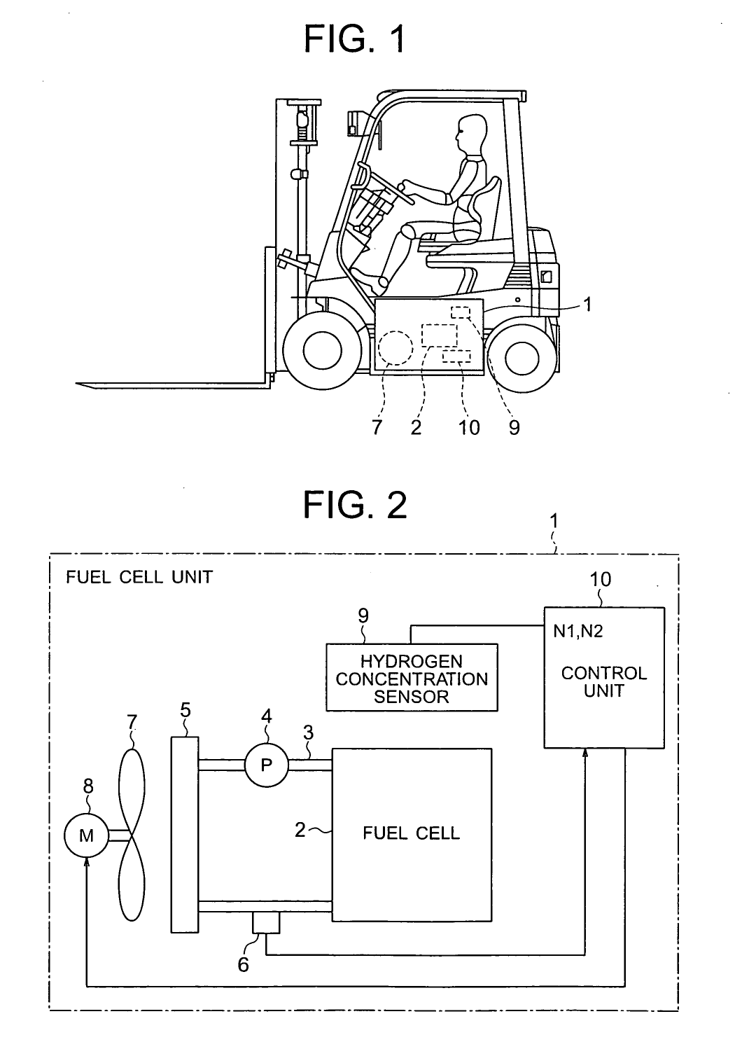

FIG. 1 shows the configuration of a fuel cell powered forklift including an abnormality detecting device according to the first embodiment of the present invention. A fuel cell unit 1 is located below a driver seat of the forklift. As shown in FIG. 2, a fuel cell 2 which functions as a driving source of the forklift is contained in the fuel cell unit 1. A coolant water circulating pump 4 and a radiator 5 are coupled with the fuel cell 2 through a coolant water passage 3, and a temperature sensor 6 which detects a temperature of coolant water is disposed in the coolant water passage 3. Also, a fan 7 for cooling and a fan motor 8 are disposed in the vicinity of the radiator 5.

Furthermore, a hydrogen concentration sensor 9 which detects the hydrogen concentration in the fuel cell unit 1 is disposed above the fuel cell 2, and the hydrogen concentration sensor 9 is connected to a control unit 10 which constitutes an abnormality determining means according to the present invention. The control unit 10 stores a first setting concentration N1 for abnormality detection and a second setting concentration N2 for abnormality detection that is set to a value lower than the first setting concentration N1 therein in advance.

The control unit 10 is also coupled with the temperature sensor 6 and the fan motor 8.

In addition, components for operating the fuel cell 2 such as a regulator for hydrogen supply, an air compressor, a humidification module, a capacitor, a battery and so on are contained in the fuel cell unit 1.

When the fuel cell 2 operates, the coolant water circulating pump 4 is driven, and the coolant water for cooling the fuel cell 2 circulates between the fuel cell 2 and the radiator 5 through the coolant water passage 3. When the temperature of the coolant water which is detected by the temperature sensor 6 exceeds a predetermined value, the control unit 10 drives the fan motor 8 to rotate the fan 7, thereby cooling the coolant water that passes through the radiator 5.

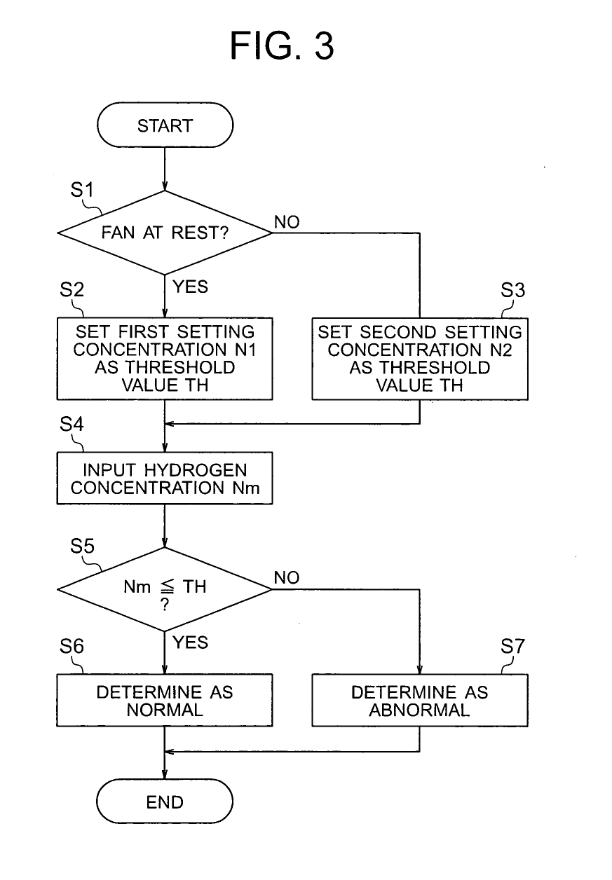

Next, a method of detecting abnormality in the first embodiment will be described with reference to the flowchart of FIG. 3. First, in Step S1, the control unit 10 confirms whether the fan 7 is at rest or not. When the fan 7 is at rest, the control unit 10 selects the first setting concentration N1 which is set to a higher concentration value from the first setting concentration N1 and the second setting concentration N2 which are stored in advance, and sets the selected first setting concentration N1 as an abnormality detection threshold value TH in Step S2.

Then, the control unit 10 inputs a hydrogen concentration Nm detected by the hydrogen concentration sensor 9 in Step S4, and compares the hydrogen concentration Nm with the abnormality detection threshold value TH in the subsequent Step S5.

When the hydrogen concentration Nm detected in Step S5 is lower than or equal to the abnormality detection threshold value TH, the control unit 10 determines that the hydrogen concentration in the fuel cell unit 1 falls within a normal range, and that the fuel cell 2 is operating normally in Step S6.

On the other hand, when the hydrogen concentration Nm detected in Step S5 exceeds the abnormality detection threshold value TH, the control unit 10 determines that the amount of emission of hydrogen from the fuel cell 2 has abnormally increased and that the fuel cell 2 is operating abnormally in Step S7.

Furthermore, when the control unit 10 confirms that the fan 7 is driven in Step S1, the control unit 10 selects the second setting concentration N2 which is set to a lower concentration value from the first setting concentration N1 and the second setting concentration N2 which are stored in advance, and sets the selected second setting concentration N2 as the abnormality detection threshold value TH in Step S3.

Then, the control unit 10 inputs the hydrogen concentration Nm detected by the hydrogen concentration sensor 9 in Step S4, and compares the hydrogen concentration Nm with the abnormality detection threshold value TH in the subsequent Step S5. If the detected hydrogen concentration Nm is lower than or equal to the abnormality detection threshold value TH, the control unit 10 determines that the fuel cell 2 is operating normally in Step S6. On the other hand, if the detected hydrogen concentration Nm exceeds the abnormality detection threshold value TH, the control unit 10 determines that the fuel cell 2 is operating abnormally in Step S7.

As described above, when the fan 7 is at rest, the control unit 10 selects the first setting concentration N1, and when the fan 7 is driven, the control unit 10 selects the second setting concentration N2 that is set to the relatively lower concentration value in consideration of reduction in the hydrogen concentration resulting from agitating the surrounding atmosphere of the fuel cell 2 in the fuel cell unit 1. Accordingly, the control unit 10 sets each of the selected setting concentrations as the abnormality detection threshold value TH respectively. As a result, it is possible to detect an abnormality with precision regardless of whether the fan 7 is driven or at rest.

For example, the first setting concentration N1 can be set to 4000 ppm, and the second setting concentration N2 can be set to 200 ppm. However, since the hydrogen concentration that is the threshold value is different according to an amount of allowable hydrogen leakage and the installation position of the hydrogen concentration sensor 9 in the fuel cell unit 1 to which the present invention is applied, it is desirable to measure the hydrogen concentration and determine an appropriate value.

When the control unit 10 determines that the operation of the fuel cell 2 is abnormal in Step S7, it is desirable that the control unit 10 stop the operation of the fuel cell 2 and notifies the driver of the abnormality by issuing a warning such as a warning lamp, buzzer, or the like, which is disposed near the driver seat of the forklift.

### Second Embodiment

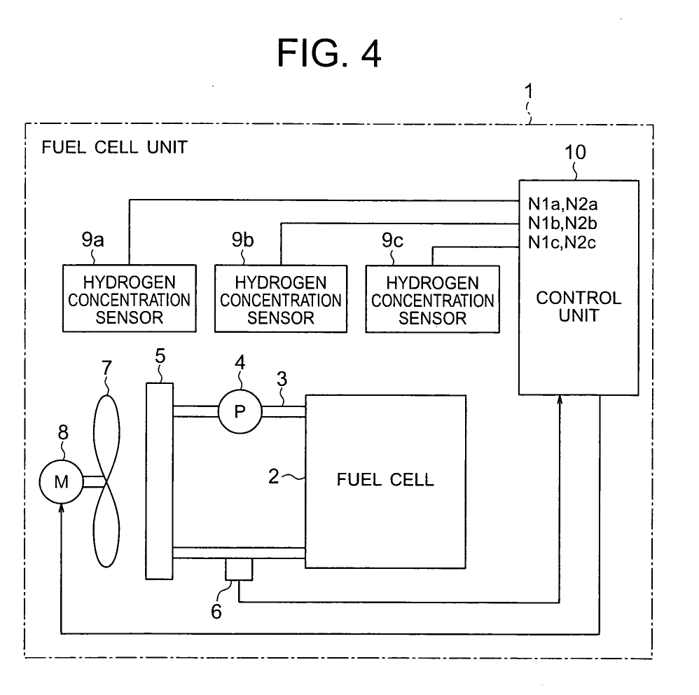

FIG. 4 shows the configuration of an abnormality detecting device according to the second embodiment. The abnormality detecting device arranges three hydrogen concentration sensors 9a to 9c at positions different from each other in the fuel cell unit 1 instead of the hydrogen concentration sensor 9 in the device of the first embodiment shown in FIG. 2, and those hydrogen concentration sensors 9a to 9c connect to the control unit 10.

The control unit 10 sets the values of the first setting concentrations and the second setting concentrations respectively according to the respective installation positions with respect to those three hydrogen concentration sensors 9a to 9c. That is, the control unit 10 sets the value of the first setting concentration N1a when the fan 7 is at rest and the value of the second setting concentration N2a when the fan 7 is driven respectively, with respect to the hydrogen concentration sensor 9a. Similarly, the control unit 10 sets the value of the first setting concentration N1b when the fan 7 is at rest and the value of the second setting concentration N2b when the fan 7 is driven respectively, with respect to the hydrogen concentration sensor 9b. Furthermore, the control unit 10 sets the value of the first setting concentration N1c when the fan 7 is at rest and the value of the second setting concentration N2c when the fan 7 is driven respectively, with respect to the hydrogen concentration sensor 9c.

Then, the control unit 10 compares the hydrogen concentrations detected by the three hydrogen concentration sensors 9a to 9c with the abnormality detection threshold values that are the setting concentrations which are set with respect to the respective hydrogen concentration sensors 9a to 9c, and determines that the operation of the fuel cell 2 is abnormal when the hydrogen concentration detected by any one of the hydrogen concentration sensors exceeds the abnormality detection threshold value.

As described above, since the hydrogen concentrations are detected by the three hydrogen concentration sensors 9a to 9c which are located at positions different from each other in the fuel cell unit 1 respectively, it is possible to detect an abnormality with precision even when the space in the fuel cell unit 1 has a complicated configuration, or even when airflow in the fuel cell unit 1 at the time of driving the fan 7 changes intricately.

Likewise, two hydrogen concentration sensors, or four or more hydrogen concentration sensors can be located at positions different from each other in the fuel cell unit 1, thereby enabling hydrogen concentrations to be detected.

### Third Embodiment

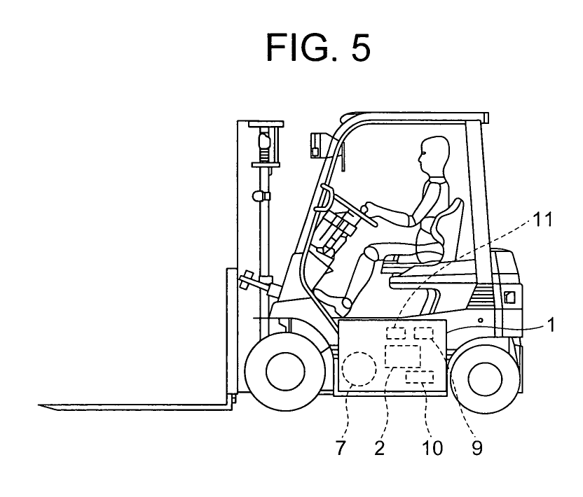

FIG. 5 shows the configuration of a fuel cell powered forklift including an abnormality detecting device according to the third embodiment. The abnormality detecting device according to the third embodiment arranges two sensors consisting of a first hydrogen concentration sensor 11 and a second hydrogen concentration sensor 12 above the fuel cell 2 in the fuel cell unit 1 instead of the hydrogen concentration sensor 9 in the device of the above-mentioned first embodiment. The second hydrogen concentration sensor 12 has detection sensitivity for a concentration that is lower than a concentration detected by the first hydrogen concentration sensor 11.

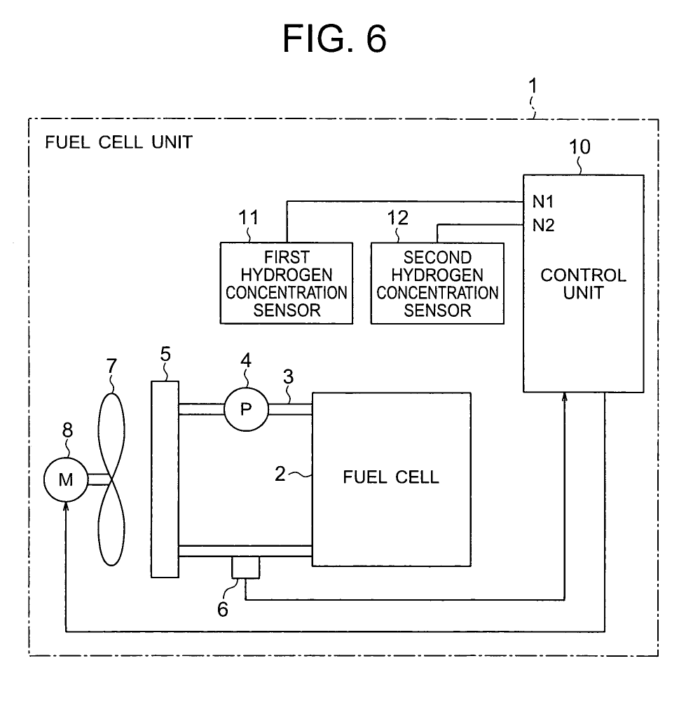

As shown in FIG. 6, the first hydrogen concentration sensor 11 and the second hydrogen concentration sensor 12 are coupled with the control unit 10 respectively.

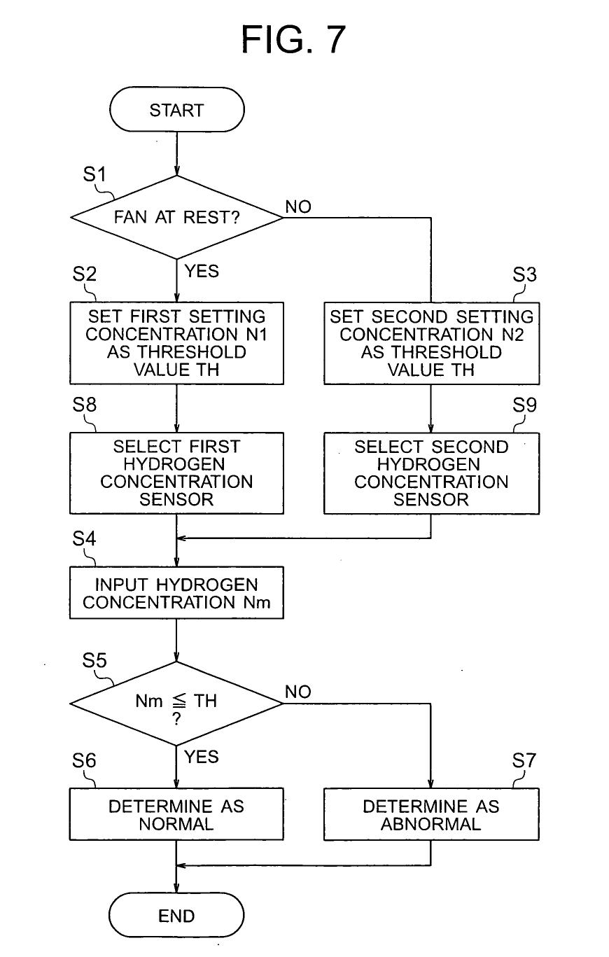

Next, a method of detecting an abnormality in the third embodiment will be described with reference to the flowchart of FIG. 7. In Step S1, the control unit 10 confirms whether the fan 7 is at rest or not. When the fan 7 is at rest, the control unit 10 selects the first setting concentration N1 which is set to the higher concentration value from the first setting concentration N1 and the second setting concentration N2 which are stored in advance, and sets the selected first setting concentration N1 as an abnormality detection threshold value TH in Step S2. The control unit 10 then selects the first hydrogen concentration sensor 11 in the subsequent Step S8.

Then, the control unit 10 inputs a hydrogen concentration Nm detected by the first hydrogen concentration sensor 11 in Step S4, and compares the hydrogen concentration Nm with the abnormality detection threshold value TH in the subsequent Step S5. If the detected hydrogen concentration Nm is lower than or equal to the abnormality detection threshold value TH, the control unit 10 determines that the fuel cell 2 is operating normally in Step S6. On the other hand, if the detected hydrogen concentration Nm exceeds the abnormality detection threshold value TH, the control unit 10 determines that the fuel cell 2 is operating abnormally in Step S7.

Also, when the control unit 10 confirms that the fan 7 is driven in Step S1, the control unit 10 selects the second setting concentration N2 which is set to the lower concentration value from the first setting concentration N1 and the second setting concentration N2 which are stored in advance, and sets the selected second setting concentration N2 as the abnormality detection threshold value TH in Step S3. Then, the control unit 10 selects the second hydrogen concentration sensor 12 for lower concentration detection in the subsequent Step S9.

Then, the control unit 10 inputs the hydrogen concentration Nm detected by the second hydrogen concentration sensor 12 in Step S4, and compares the hydrogen concentration Nm with the abnormality detection threshold value TH in the subsequent Step S5. If the detected hydrogen concentration Nm is lower than or equal to the abnormality detection threshold value TH, the control unit 10 determines that the fuel cell 2 is operating normally in Step S6. On the other hand, if the detected hydrogen concentration Nm exceeds the abnormality detection threshold value TH, the control unit 10 determines that the fuel cell 2 is operating abnormally in Step S7.

As described above, when the fan 7 is at rest, the control unit 10 selects the first hydrogen concentration sensor 11, and when the fan 7 is driven, the control unit 10 selects the second hydrogen concentration sensor 12 for lower concentration detection in consideration of reduction in the hydrogen concentration resulting from agitating the surrounding atmosphere of the fuel cell 2 in the fuel cell unit 1, and compares the hydrogen concentration Nm detected by the selected sensor with the abnormality detection threshold value TH. As a result, it is possible to detect an abnormality with precision regardless of whether the fan 7 is driven or at rest.

### Fourth Embodiment

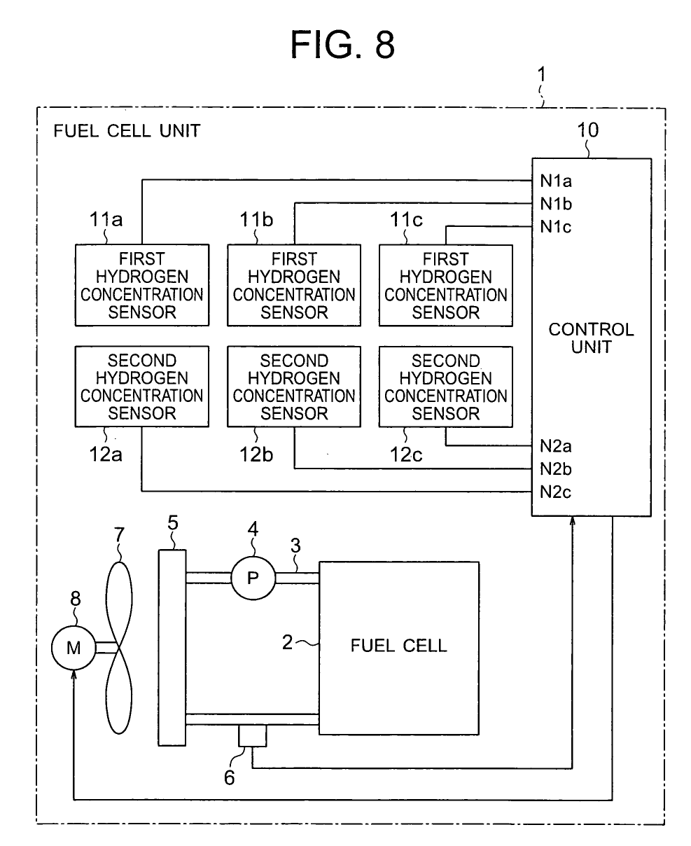

FIG. 8 shows the configuration of an abnormality detecting device according to the fourth embodiment. The abnormality detecting device arranges three first hydrogen concentration sensors 11a to 11c and three second hydrogen concentration sensors 12a to 12c at positions different from each other in the fuel cell unit 1 instead of the first hydrogen concentration sensor 11 and the second hydrogen concentration sensor 12 in the device of the third embodiment shown in FIG. 6, and these hydrogen concentration sensors connect to the control unit 10. The second hydrogen concentration sensors 12a to 12c have a concentration detection sensitivity lower than the concentration detection sensitivity of the first hydrogen concentration sensors 11a to 11c.

The control unit 10 sets the values of first setting concentrations N1a to N1c according to the respective installation positions with respect to these three first hydrogen concentration sensors 11a to 11c and the values of second setting concentrations N2a to N2c according to the respective installation positions with respect to these three second hydrogen concentration sensors 12a to 12c.

Then, the control unit 10 selects the first hydrogen concentration sensors 11a to 11c when the fan 7 is at rest, and compares the hydrogen concentrations detected by the first hydrogen concentration sensors 11a to 11c with the abnormality detection threshold values that are the first setting concentrations N1a to N1c respectively. If the hydrogen concentration detected by any one of the first hydrogen concentration sensors 11a to 11c exceeds the abnormality detection threshold value, the control unit 10 determines that the operation of the fuel cell 2 is abnormal.

On the other hand, the control unit 10 selects the second hydrogen concentration sensors 12a to 12c when the fan 7 is driven, and compares the hydrogen concentrations detected by the second hydrogen concentration sensors 12a to 12c with the abnormality detection threshold values that are the second setting concentrations N2a to N2c respectively. If the hydrogen concentration detected by any one of the second hydrogen concentration sensors 12a to 12c exceeds the abnormality detection threshold value, the control unit 10 determines that the operation of the fuel cell 2 is abnormal.

As described above, hydrogen concentrations are detected by the three first hydrogen concentration sensors 11a to 11c and the three second hydrogen concentration sensors 12a to 12c that are located at positions different from each other in the fuel cell unit 1 respectively, thereby making it possible to detect an abnormality with precision and with high accuracy.

In the fourth embodiment, three pairs of first hydrogen concentration sensor and second hydrogen concentration sensor are used. However, the present invention is not limited to the above configuration. Two, four, or more pairs of the first hydrogen concentration sensor and second hydrogen concentration sensor can be located at positions different from each other in the fuel cell unit 1 to detect hydrogen concentrations.

### Fifth Embodiment

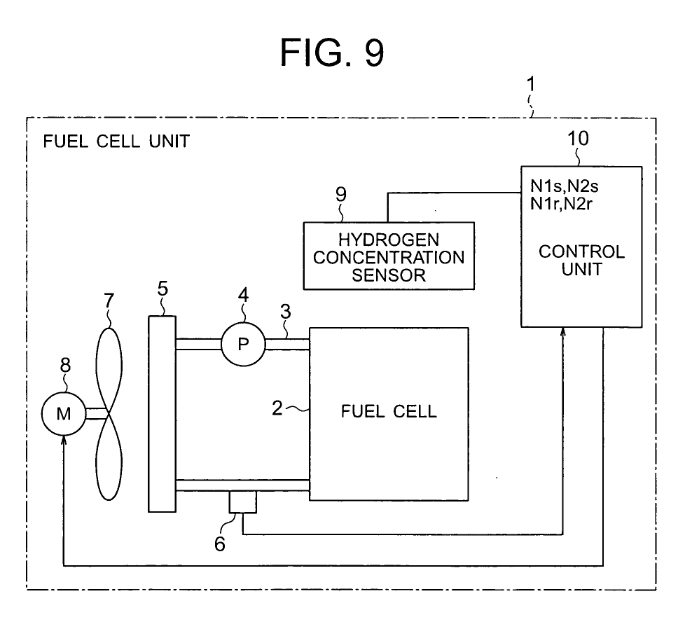

FIG. 9 shows the configuration of an abnormality detecting device according to the fifth embodiment. In the abnormality detecting device, the control unit 10 detects an abnormality by using different setting concentrations at the time of stopping the forklift and at the time of running the forklift in the device of the first embodiment shown in FIG. 2. The control unit 10 stores a first concentration at the time of stopping N1s when the forklift stops and a first concentration at the time of running N1r when the forklift runs which is set to a value lower than the first concentration at the time of stopping N1s therein in advance, as a first setting concentration when the fan 7 is at rest. Also, the control unit 10 stores a second concentration at the time of stopping N2s when the forklift stops and a second concentration at the time of running N2r when the forklift runs which is set to a value lower than the second concentration at the time of stopping N2s therein in advance, as a second setting concentration when the fan 7 is driven.

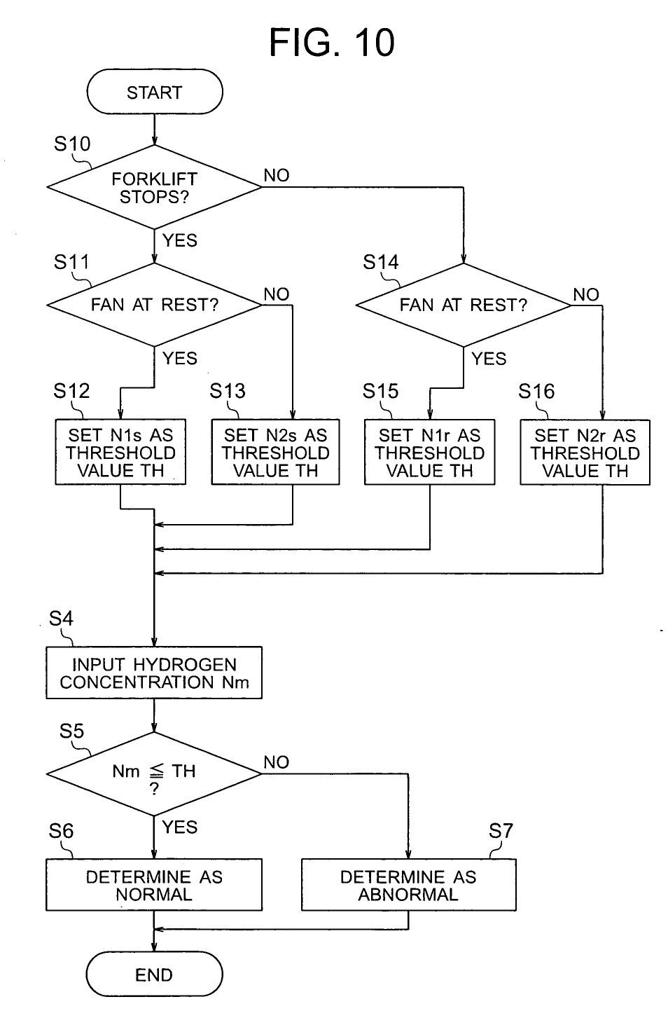

Next, a method of detecting an abnormality in the fifth embodiment will be described with reference to the flowchart of FIG. 10. First, in Step S10, the control unit 10 determines whether the forklift is stopped or running. When the forklift is stopped, the control unit 10 confirms whether the fan 7 is at rest or not in Step S11. When the fan 7 is at rest, the control unit 10 selects the first concentration at the time of stopping N1s stored in advance in Step S12, and when the fan 7 is driven, the control unit 10 selects the second concentration at the time of stopping N2s stored in advance in Step S13. On the other hand, when the control unit 10 determines that the forklift is running in Step S10, the control unit 10 confirms whether the fan 7 is at rest or not in Step S14. When the fan 7 is at rest, the control unit 10 selects the first concentration at the time of running N1r stored in advance in Step S15, and when the fan 7 is driven, the control unit 10 selects the second concentration at the time of running N2r stored in advance in Step S16.

After the control unit 10 sets one concentration selected from the first concentration at the time of stopping N1s, the second concentration at the time of stopping N2s, the first concentration at the time of running N1r, and the second concentration at the time of running N2r as an abnormality detection threshold value TH as described above, the control unit 10 inputs the hydrogen concentration Nm detected by the hydrogen concentration sensor 9 in Step S4. In the subsequent Step S5, the control unit 10 compares the hydrogen concentration Nm with the abnormality detection threshold value TH. If the detected hydrogen concentration Nm is lower than or equal to the abnormality detection threshold value TH, the control unit 10 determines that the fuel cell 2 is operating normally in Step S6. On the other hand, if the detected hydrogen concentration Nm exceeds the abnormality detection threshold value TH, the control unit 10 determines that the operation of the fuel cell 2 is abnormal in Step S7.

As described above, when the forklift is stopped, the control unit 10 selects the first concentration at the time of stopping N1s or the second concentration at the time of stopping N2s, and when the forklift is running, the control unit 10 selects the first concentration at the time of running N1r or the second concentration at the time of running N2r which are set to relatively lower concentration values in consideration of reduction in the hydrogen concentration resulting from agitating the surrounding atmosphere of the fuel cell 2 in the fuel cell unit 1 due to an occurrence of an airflow caused by the running of the forklift, and sets the selected concentration as the abnormality detection threshold value TH. As a result, it is possible to detect an abnormality with high accuracy regardless of whether the forklift is stopped or running and whether the fan 7 is at rest or driven.

The fifth embodiment can be applied to the abnormality detecting devices of the above-mentioned second to fourth embodiments to set the setting concentrations different according to whether the forklift is stopped or running as the abnormality detection threshold values.

Also, the present invention is not limited to forklifts, but can be applied to various industrial vehicles including fuel cell units with the fuel cell as a driving source.

What is claimed is:

1. An abnormality detecting device for a fuel cell powered industrial vehicle, the vehicle including a fuel cell unit having a fuel cell and which starts a radiator fan to cool the fuel cell when the fuel cell is overheated, the abnormality detecting device comprising:
a hydrogen concentration detecting device arranged in the fuel cell unit; and
a control device in which a first setting concentration set as an abnormality detecting threshold value when the fan is at rest and a second setting concentration set as an abnormality detecting threshold value that is lower than the first setting concentration when the fan is driven,
wherein the control device determines there is an abnormality when the hydrogen concentration that is detected by the hydrogen concentration detecting device exceeds the abnormality detection threshold value.

2. The abnormality detecting device for a fuel cell powered industrial vehicle according to claim 1, wherein the hydrogen concentration detecting device comprises one hydrogen concentration sensor.

3. The abnormality detecting device for a fuel cell powered industrial vehicle according to claim 1,
wherein the hydrogen concentration detecting device comprises a plurality of hydrogen concentration sensors that are located at different positions in the fuel cell unit; and
wherein the control device sets the values of the first setting concentration and the second setting concentration respectively according to respective installation positions with respect to the plurality of hydrogen concentration sensors, and determines there is an abnormality when the hydrogen concentration detected by any one of the plurality of hydrogen concentration sensors exceeds the abnormality detection threshold value.

4. The abnormality detecting device for a fuel cell powered industrial vehicle according to claim 1,
wherein the hydrogen concentration detecting device comprises at least one first hydrogen concentration sensor and at least one second hydrogen concentration sensor for detecting a concentration that is lower than a concentration detected by the first hydrogen concentration sensor; and
wherein the control device determines there is an abnormality by using the hydrogen concentration detected by the first hydrogen concentration sensor when the fan is at rest and by using the hydrogen concentration detected by the second hydrogen concentration sensor when the fan is driven respectively.

5. The abnormality detecting device for a fuel cell powered industrial vehicle according to claim 4,
wherein the hydrogen concentration detecting device comprises a plurality of first hydrogen concentration sensors that are located at different positions in the fuel cell unit and a plurality of second hydrogen concentration sensors that are located at different positions in the fuel cell unit and detect a concentration that is lower than a concentration detected by the plurality of first hydrogen concentration sensors; and
wherein the control device sets the value of the first setting concentration according to respective installation positions with respect to the plurality of first hydrogen concentration sensors and the value of the second setting concentration according to respective installation positions with respect to the plurality of second hydrogen concentration sensors, and determines there is an abnormality when the hydrogen concentration detected by any one of the plurality of first hydrogen concentration sensors and the plurality of second hydrogen concentration sensors exceeds the abnormality detection threshold value.

6. The abnormality detecting device for a fuel cell powered industrial vehicle according to claim 1,
wherein the control device selects a first concentration at the time of stopping when the fuel cell powered industrial vehicle stops and a first concentration at the time of running when the fuel cell powered industrial vehicle is running lower than the first concentration at the time of stopping, as the first setting concentration respectively; and
wherein the control device selects a second concentration at the time of stopping when the fuel cell powered industrial vehicle stops and a second concentration at the time of running when the fuel cell powered industrial vehicle is running lower than the second concentration at the time of stopping, as the second setting concentration respectively.

7. The abnormality detecting device for a fuel cell powered industrial vehicle according to claim 1, wherein the control device stops operation of the fuel cell when an abnormality is determined.

8. An abnormality detecting device for a fuel cell powered industrial vehicle, the vehicle including a fuel cell unit having a fuel cell and which starts a radiator fan to cool the fuel cell when the fuel cell is overheated, the abnormality detecting device comprising:
hydrogen concentration detecting means for detecting a hydrogen concentration in the fuel cell unit; and
an abnormality determining means for selecting a first setting concentration when the fan is at rest and selecting a second setting concentration that is lower than the first setting concentration when the fan is driven as the respective abnormality detection threshold values, and determining there is an abnormality when the hydrogen concentration that is detected by the hydrogen concentration detecting means exceeds the abnormality detection threshold value.
